(19) United States
(12) Patent Application Publication
(10) Pub. No.: US 2015/0142409 A1
(43) Pub. Date: May 21, 2015

(54) PHOTOGRAPHIC SETUP MODELING

(71) Applicant: International Business Machines Corporation, Armonk, NY (US)

(72) Inventors: Michael C. Collins, Raleigh, NC (US); John F. Kelley, Clarkesville, GA (US); Douglas E. Lhotka, Highlands Ranch, CO (US); Todd P. Seager, Orem, UT (US)

(73) Assignee: International Business Machines Corporation, Armonk, NY (US)

(21) Appl. No.: 14/085,875

(22) Filed: Nov. 21, 2013

(51) Int. Cl. G06F 17/50

(52) U.S. Cl. CPC G06F 17/5009
USPC 703/13

(57) ABSTRACT

In an approach for simulating a photographic setup, a computer receives information detailing a first type of device. The computer determines the received first type of device is not included in a device database. The computer inserts the first type of device into the device database. The computer receives a selection of one or more types of devices. The one or more selected types of devices are included in the device database and include the first type of device. The computer receives a configuration for each of the one or more selected types of devices. The computer creates a simulation of a photographic setup. The simulation is based on the one or more selected types of devices and the received configurations.

### FIELD OF THE INVENTION

The present invention relates generally to the field of photography, and more particularly to modeling setups for photography.

### BACKGROUND OF THE INVENTION

Light is the building block of every great photograph, and today there are tools that allow artists to shape light creatively. The proper illumination of a subject being photographed is often important in the production of high quality photography, and photographers utilize a wide variety of lighting devices in achieving the desired illumination. Artificial illumination includes direct lighting and indirect lighting, and a variety of light reflectors, flash units, strobes, and other light sources are employed to achieve the desired result. Typically, the light source is stationary with respect to the subject being photographed and the camera, and the intensity of the illumination, the distance of the illuminating devices from the subject, the reflective quality of the subject, the aperture setting of the camera, and the lens to be used, all affect the illumination characteristics with respect to the end result achieved, and photographers often go to great lengths to achieve the desired lighting effect.

Digital cameras are used by a growing number of consumer and professional photographers. These cameras use an image sensor to capture images, and digitally process the captured image to produce a digital image file, which is stored in a digital memory. Digital image files originating from a digital camera include the digital images and may also include metadata generated from the digital camera. Image metadata is essentially non-picture information embedded in the digital image file in addition to the actual image data. The metadata can be relevant information fundamental to the camera's function at the time of image capture, such as shutter speed, aperture, focal length, date, time, etc.

### SUMMARY

Embodiments of the present invention disclose a method, computer program product, and system for simulating a photographic setup. The method includes a computer receiving information detailing a first type of device. The computer determines the received first type of device is not included in a device database. The computer inserts the first type of device into the device database. The computer receives a selection of one or more types of devices. The one or more selected types of devices are included in the device database and include the first type of device. The computer receives a configuration for each of the one or more selected types of devices. The computer creates a simulation of a photographic setup. The simulation is based on the one or more selected types of devices and the received configurations.

### BRIEF DESCRIPTION OF THE SEVERAL VIEWS OF THE DRAWINGS

FIG. 1 is a functional block diagram illustrating a photographic setup environment, in accordance with an embodiment of the present invention.

FIG. 2 is a flowchart depicting operational steps of a modeling program, on a computing device within the photographic setup environment of FIG. 1, for populating an inventory list, in accordance with an embodiment of the present invention.

FIG. 3 is a flowchart depicting operational steps of a modeling program, on a computing device within the photographic setup environment of FIG. 1, for simulating a photographic setup, in accordance with an embodiment of the present invention.

FIG. 4 is a flowchart depicting operational steps of a modeling program, on a computing device within the photographic setup environment of FIG. 1, for checking in equipment after a photographic shoot, in accordance with an embodiment of the present invention.

FIG. 5 depicts a block diagram of components of the computing device executing the modeling program, in accordance with an embodiment of the present invention.

### DETAILED DESCRIPTION

Photographers typically sketch out photographic setups for a photographic shoot in a studio or before arriving on location. These sketches are then used to set up equipment such as lighting, props, etc. before a photographic shoot. Often, the photographer does not know if the equipment is set up correctly until the equipment setup is tested. Setup can be iterative, and therefore setup time can be tedious. Prolonged setup time may take away from time with clients and subjects, and may negatively affect the creative aspects of the photographic shoot.

Embodiments of the present invention recognize efficiency could be gained if the process for setting up a photographic shoot could be made more predictable and less time consuming. Embodiments of the present invention simulate the photographic setup using virtual representations of equipment in the photographer's inventory. Implementation of embodiments of the invention may take a variety of forms, and exemplary implementation details are discussed subsequently with reference to the Figures.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

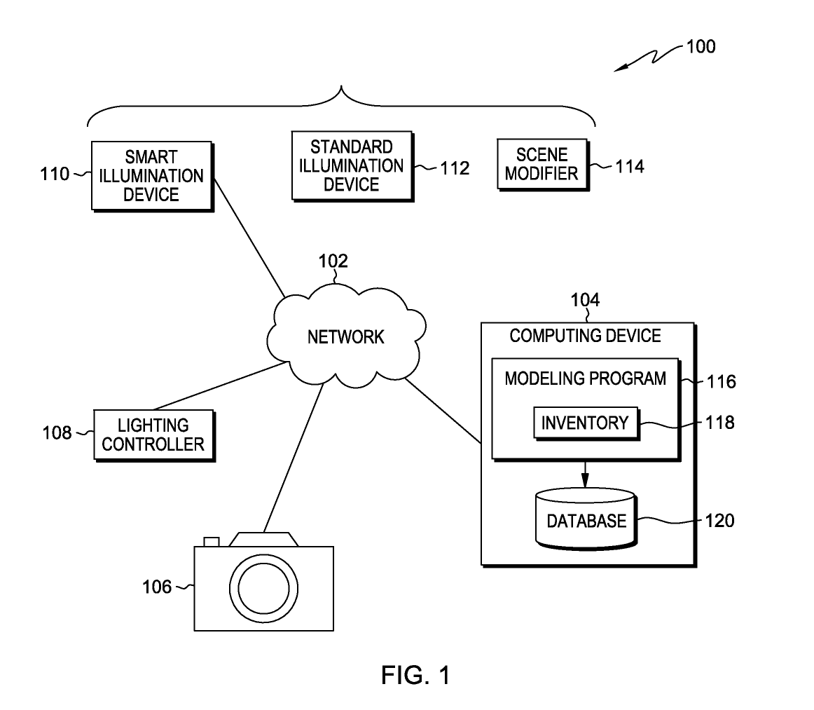

The present invention will now be described in detail with reference to the Figures. FIG. 1 is a functional block diagram illustrating a photographic setup environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

In the illustrated embodiment, photographic setup environment 100 includes computing device 104, camera 106, lighting controller 108, smart illumination device 110, standard illumination device 112, and scene modifier 114. Computing device 104, camera 106, lighting controller 108, and smart illumination device 110 are all interconnected over network 102. Network 102 can be, for example, a local area network (LAN), a wide area network (WAN) such as the Internet, or a combination of the two, and can include wired, wireless, or fiber optic connections. In general, network 102 can be any combination of connections and protocols that will support communications between computing device 104, camera 106, lighting controller 108, and smart illumination device 110.

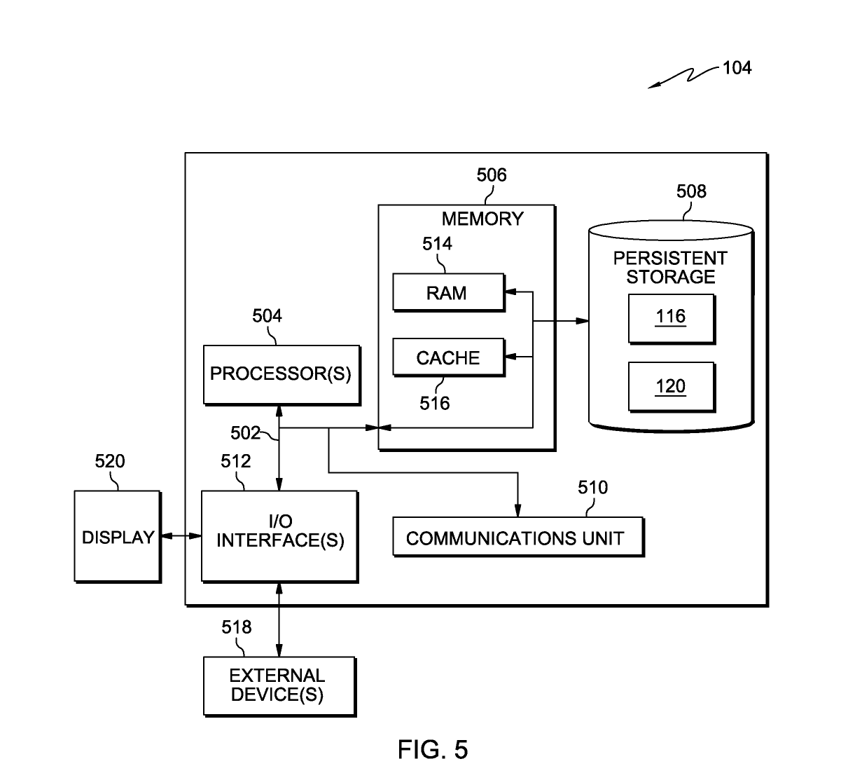

Computing device 104 may be a desktop computer, a laptop computer, a tablet computer, a specialized computer server, a smartphone, or any other computer system known in the art. In another embodiment, computing device 104 represents a computing system utilizing clustered computers and components to act as a single pool of seamless resources. In general, computing device 104 represents any programmable electronic device or combination of programmable electronic devices capable of executing machine-readable program instructions and communicating with other computing devices via a network, such as network 102. Computing device 104 includes modeling program 116 and database 120. Computing device 104 may include internal and external hardware components, as depicted and described in further detail with respect to FIG. 5.

Camera 106 is a photography device, such as a digital camera, enabled with the capability of communicating with other devices via network 102. Camera 106 may also be a digital camera that resides in a portable electronic device, such as a smartphone. Camera 106 is also enabled with the capability of collecting and storing metadata within each image for the purpose of documenting details of the image that was captured. The metadata may include details such as shutter speed, lens, camera location, aperture, focal length, etc. In one embodiment, camera 106 also includes the ability to receive and store metadata received from other devices in a photographic setup, or shoot, in resident memory. For example, lighting metadata may include information such as manufacturer, model number, light intensity, power, orientation, position, location, etc.

Smart illumination device 110 may be any illumination device, e.g. strobe light, static light and/or flash, which includes an embedded or attached electronic device with the capability of collecting lighting metadata at the moment of image capture and transmitting the lighting metadata over network 102. Lighting metadata may include attributes such as manufacturer, model number, light intensity, power, orientation, position, location, etc. Smart illumination device 110 may also have the capability of detecting scene modifiers. As discussed in more detail below, scene modifiers are objects or devices capable of modifying a photographic setup, typically with regards to the illumination of the scene. In an exemplary embodiment, smart illumination device 110 includes a user interface that displays a list of modifiers from which the user can select for the current setup. In another embodiment, the modifier may have an embedded RFID chip which transmits the modifier metadata to smart illumination device 110. Modifier metadata may include attributes such as manufacturer, model number, size, color, etc. Smart illumination device 110 may also be enabled with the capability of detecting fixed or relative location of smart illumination device 110. In an exemplary embodiment, smart illumination device 110 detects location by the inclusion of a global positioning system (GPS). In another embodiment, the capability of detecting location is enabled by the use of radio/optical triangulation with respect to camera 106 and/or other devices in the photographic setup. Smart illumination device 110 may also be enabled with the capability to issue an audible or visual cue to the user to indicate various circumstances. For example, smart illumination device 110 may issue a cue to alert the user that smart illumination device 110 is not placed in the correct position relative to previously stored metadata. In another example, smart illumination device 110 may issue a cue to the user to indicate whether or not smart illumination device 110 is included in a pre-set configuration of a photographic setup. Smart illumination device 110 may also include servos which can adjust for placement along an axis or to zoom a strobe lens. In one embodiment, smart illumination device 110 includes the ability to transmit directions to attached servos in order to activate the servos in lighting supports to raise, lower and/or move smart illumination device 110 to the desired configuration.

Standard illumination device 112 is any photographic illumination device that does not include an embedded electronic device with the capability of collecting lighting metadata at the moment of image capture and/or transmitting lighting metadata over network 102. Standard illumination device 112 may be a strobe light, a static light, a flash, or any illumination device capable of illuminating a photographic setup. In the depicted environment, standard illumination device 112 does not communicate over network 102. In another embodiment, an electronic identification tag may be attached to standard illumination device 112 to enable communication capabilities similar to that of smart illumination device 110. In yet another embodiment, a device that allows a user to input orientation and/or position may be attached to standard illumination device 112 such that standard illumination device 112 is able to adjust to the desired settings.

Lighting controller 108 may be a desktop computer, a laptop computer, a tablet computer, a specialized computer server, a smartphone, or any other computer system known in the art. In general, lighting controller 108 represents any programmable electronic device or combination of programmable electronic devices capable of executing machine-readable program instructions and communicating with other computing devices via a network, such as network 102. Lighting controller 108 is enabled with the capability of changing the quality of light of one or more illumination devices in a photographic setup, or shoot, for example, controlling when a strobe light will fire or changing the intensity of a light. Lighting controller 108 may communicate with smart illumination devices using any wireless communications protocol, for example, Bluetooth®, NFC (Near Field Communications) protocols, RFID (radio-frequency identification), Wi-Fi®, or cellular communications. Lighting controller 108 may also communicate with other devices, such as smart illumination device 110 and standard illumination device 112, using wired communications. Lighting controller 108 may transmit stored settings to one or more illumination devices in the photographic setup. Lighting controller 108 may also receive settings from one or more illumination devices for storing for use at a later time, or for comparison to pre-defined settings for determination of whether the illumination device is set correctly. Lighting controller 108 may include non-volatile memory for storing pre-set conditions. In the embodiment depicted in FIG. 1, lighting controller 108 is a stand-alone device. In another embodiment, lighting controller 108 may be embedded within the electronics of camera 106. In yet another embodiment, lighting controller 108 may be embedded within the electronics of computing device 104.

Scene modifier 114 is an object capable of modifying a photographic setup. Examples of a scene modifier include items such as gels or filters that modify illumination devices. A color gel or color filter, also known as lighting gel or simply gel, is a transparent colored material used in photography to color light and for color correction. Modern gels are thin sheets of polycarbonate or polyester, placed in front of a lighting fixture in the path of the beam. Attributes of gels include color code and transmissive index. Another example of a scene modifier is a “soft box”. A soft box is an enclosure around a light bulb comprising reflective side and back walls and a diffusing material at the front of the light. The sides and back of the box are lined with a bright surface such as an aluminized fabric surface or an aluminum foil, to act as an efficient reflector. Yet another example of a scene modifier is an umbrella reflector. An umbrella reflector is an umbrella that is metalized on the inside and used for bouncing off light in a photographic setup to create soft indirect light. Yet another example of a scene modifier is a prop for the scene, such as a piece of furniture or a plant. In the depicted environment, scene modifier 114 does not communicate over network 102. In another embodiment, an electronic identification tag may be attached to scene modifier 114 to enable communication capabilities similar to that of smart illumination device 110. In another embodiment, a scene modifier may have an embedded RFID chip which transmits the scene modifier metadata to smart illumination device 110. Scene modifier metadata may include attributes such as manufacturer, model number, size, color, etc.

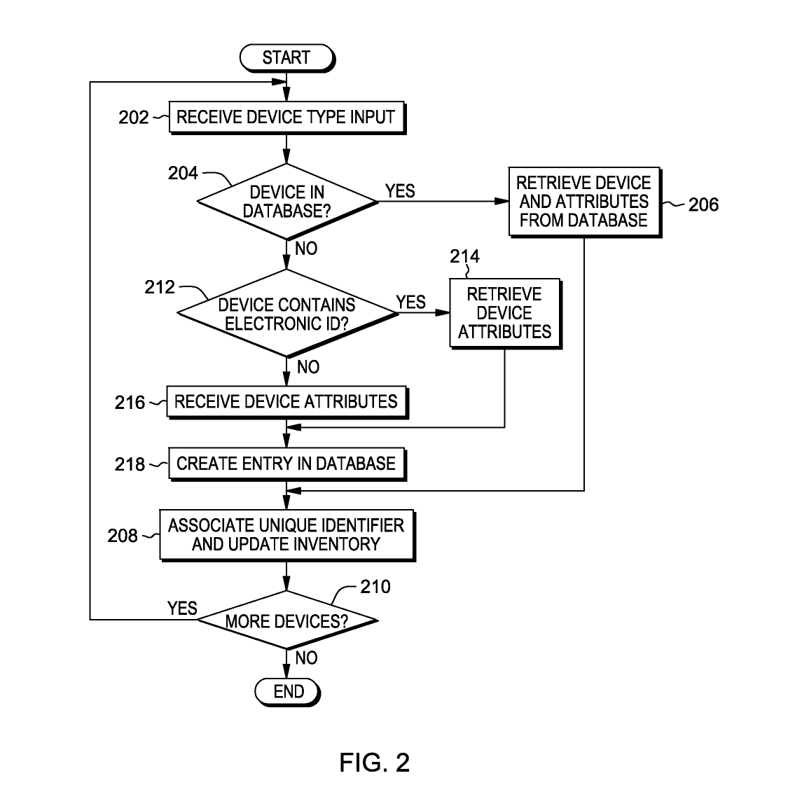

Modeling program 116 resides on computing device 104. In other embodiments, modeling program 116 may reside on any other computing device that is accessible to network 102. Modeling program 116 is a software package that contains a plurality of executable computer program instructions utilized for modeling a photographic setup. Modeling program 116 enables a user to simulate a three-dimensional photographic setup, including designing the lighting scheme based on the user's inventory of equipment. Once the simulated image is complete, the user has a basis for setting up a physical photographic shoot. Modeling program 116 includes inventory 118. Inventory 118 is a list of photographic equipment, including illumination devices and scene modifiers, from which the user chooses for a photographic setup. The user populates inventory 118 utilizing modeling program 116, as depicted and described in further detail with respect to FIG. 2.

Database 120 includes specifications and/or attributes for a plurality of photographic equipment available in the industry, as well as virtual items that may be chosen to compose a simulated photographic setup. The photographic equipment attributes may include data such as manufacturer, model number, power capability, size, etc., depending on the particular piece of equipment. Database 120 can be updated to include both new photographic equipment that becomes available in the industry and any changes to equipment already listed. Database 120 may also store samples of modeled photographic setups as well as files that include image metadata from actual photographs. In the depicted embodiment, database 120 resides in computing device 104. In another embodiment, database 120 may reside in lighting controller 108. In yet another embodiment, database 120 may reside in camera 106.

FIG. 2 is a flowchart depicting operational steps of modeling program 116 for populating inventory 118, in accordance with an embodiment of the present invention.

Modeling program 116 receives input, including a type of device, via a user interface from a user of computing device 104 (step 202). In an exemplary embodiment, the input indicates the type of device, for example, an illumination device or a scene modifier.

Modeling program 116 determines whether the type of device is included in database 120 (decision block 204). As discussed with respect to FIG. 1, database 120 contains specifications and/or attributes for a plurality of photographic equipment available in the industry. Modeling program 116 compares the received type of device indicated by the input to the device types listed in database 120, and determines whether the device exists in database 120. If the device is in database 120 (yes branch, decision block 204), modeling program 116 retrieves data associated with the type of device and its associated attributes from database 120 and presents it to the user (step 206). In an exemplary embodiment, the attributes associated with a device include a manufacturer's name and/or model number. The user of computing device 104 selects the device in database 120 that matches the device to be added to inventory 118 via a user interface, and modeling program 116 retrieves the selected device entry from database 120.

If the device is not in database 120 (no branch, decision block 204), modeling program 116 determines whether the device contains electronic identification (ID) capability (decision block 212). A smart illumination device, or, alternatively, a standard illumination device onto which an electronic ID tag has been attached (not shown), has the capability of collecting lighting metadata at the moment of image capture and transmitting lighting metadata over network 102. The lighting metadata includes the device attributes. If modeling program 116 determines that the device has an electronic ID (yes branch, decision block 212), modeling program 116 retrieves the device attributes from the smart illumination device or the electronic ID tag of a standard illumination device via network 102 (step 214).

If the device does not have an electronic ID (no branch, decision block 212), modeling program 116 receives input of the device attributes (step 216). In one embodiment, the input of the device attributes is entered manually by the user of computing device 104. In another embodiment, the user of computing device 104 may input manufacturer information regarding the device, and modeling program 116 may retrieve the device attributes directly from the manufacturer, such as from the manufacturer's server or website, via network 102.

Subsequent to retrieving device attributes via electronic tag or receiving device attributes input by the user of computing device 104, modeling program 116 creates an entry for the device in database 120 on computing device 104 (step 218). Once the device has been entered in database 120, the device and associated attributes can be retrieved from database 120.

Modeling program 116 associates a unique identifier with a device and updates inventory 118 by adding the unique identifier of the device to the inventory listing (step 208). For example, a user may have three identical strobe lights, i.e. strobe lights with the same manufacturer and model number. The user requires tracking of each of the identical strobe lights in order to account for which strobe lights are taken to a particular photographic setup. A unique identifier, such as strobe light 1, strobe light 2, strobe light 3, associated with each light enables tracking. If strobe light 2 is lost or damaged, the user can remove that particular device from the inventory. The listing of the device in database 120 includes all pertinent attributes of that device, for example, manufacturer, model number, power output, field dispersion, recycle time, etc., and those attributes are included in the device listing in inventory 118.

Modeling program 116 determines if more devices are required to be added to inventory 118 (decision block 210). If no additional devices are to be added to inventory 118, modeling program 116 completes execution (no branch, decision block 210). If additional devices are to be added to inventory 118 (yes branch, decision block 210), modeling program 116 returns to step 202 for device input. Inventory population continues until all devices are included in inventory 118.

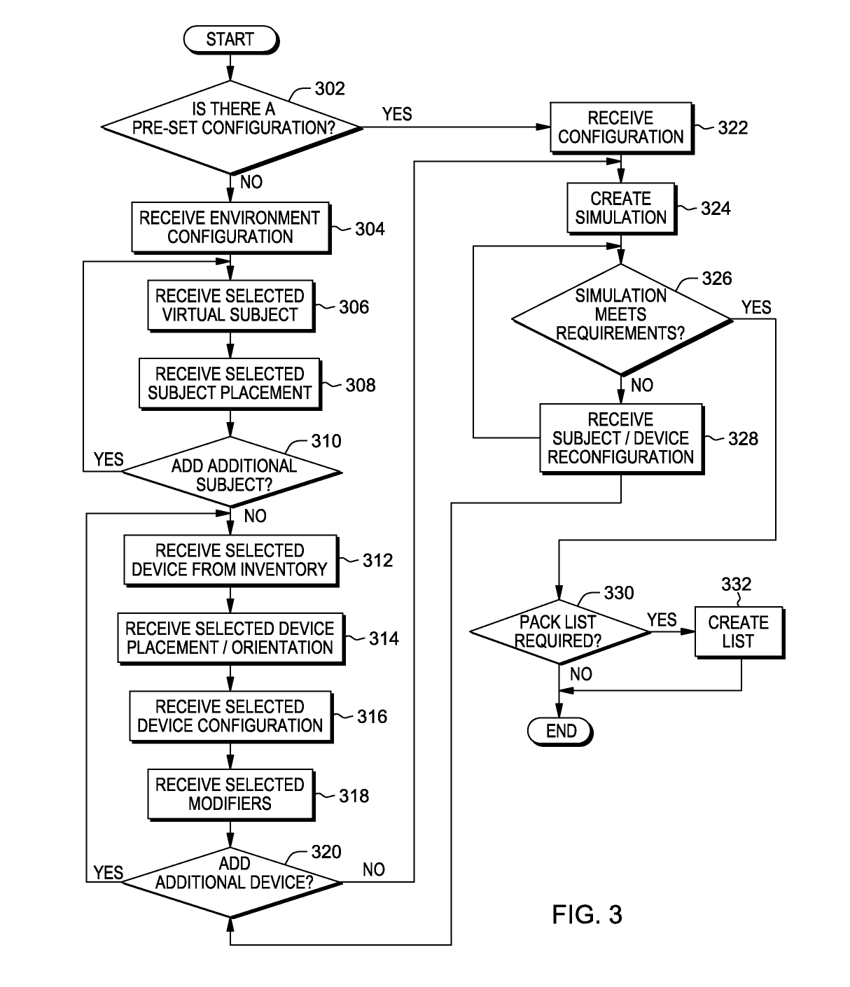

FIG. 3 is a flowchart depicting operational steps of a modeling program, on a computing device within the photographic setup environment of FIG. 1, for simulating a photographic setup, in accordance with an embodiment of the present invention. In this portion of modeling program 116, the user sets up the simulated image, including the scene, the subject and the lighting.

Modeling program 116 determines whether a pre-set configuration exists for the current image modeling (decision block 302). In one embodiment, modeling program 116 sends a query to the user, asking if the user has a pre-set configuration to use. For example, a pre-set configuration may exist in the metadata of a photograph that was taken prior to the current image modeling. In another example, a pre-set configuration may exist in a dataset from a previously modeled image. If a pre-set configuration exists (yes branch, decision block 302), modeling program 116 receives the configuration (step 322). In one embodiment, camera 106 transmits an image metadata over network 102 to computing device 104, and modeling program 116 receives the image metadata as a pre-set configuration. In another embodiment, a pre-set configuration is stored in database 120, and the user selects the photograph or file that contains the pre-set configuration for use by modeling program 116 via a user interface. Modeling program 116 identifies the pre-set configuration settings within the metadata.

If a pre-set configuration does not exist (no branch, decision block 302), modeling program 116 receives an environment configuration selected by the user from a menu of available environment attributes (step 304). The menu of available attributes is stored in database 120 of computing device 104. The environment configuration is the virtual description of the scene scale, and may include, for example, room dimensions and whether the environment is indoors or outdoors. In one embodiment, the user creates the environment configuration by choosing attributes from a menu. In another embodiment, the user may choose an environment configuration from samples stored in database 120 or from a previously created model.

Modeling program 116 receives a selected virtual subject (step 306). The user selects a subject from a menu of available subjects or from the user's previously stored images. The menu of available subjects and/or the user's previously stored images are stored in database 120 of computing device 104. For example, the subject of the image may be a person, for a portrait, or a product, for an advertisement. In one embodiment, the user selects the subject from samples stored in database 120 by choosing from a menu. In another embodiment, the user may choose a subject from a previously created model.

Subsequent to receiving the selected virtual subject, modeling program 116 receives a selected subject placement (step 308). The user may place the virtual subject in the environment configuration according to the user's preference. In one embodiment, the user selects the subject placement by clicking and dragging the subject to the preferred location on the display of computing device 104. Subsequent to subject placement, modeling program 116 determines whether to add additional subjects (decision block 310). If the user prefers to add additional subjects to the image (yes branch, decision block 310), modeling program 116 returns to step 306 and receives a selected virtual subject.

If no additional subjects are required (no branch, decision block 310), modeling program 116 receives a selected device from inventory 118 (step 312). As the user begins to model the photographic setup, the user selects an illumination device from the illumination devices listed in inventory 118. For example, the user may choose a particular strobe light from the list of strobe lights included in inventory 118.

Subsequent to receiving a device selection, modeling program 116 receives a selected device placement and/or orientation in the environment configuration (step 314). In one embodiment, the user selects the device placement by clicking and dragging the device to the preferred location on the display of computing device 104. In another embodiment, the user may input a value for the distance between the device and the subject into an on-screen menu. For example, a strobe light may be placed at a distance of three feet relative to the subject. In one embodiment, the user may input a value for the orientation of the device into an on-screen menu. For example, a strobe light may be placed at an angle of 45 degrees relative to the subject.

Subsequent to receiving a device placement/orientation selection, modeling program 116 receives a selected device configuration (step 316). In one embodiment, the user may input selections for the configuration of the device into an on-screen menu. Each device has many attributes that can be configured. For an illumination device, attributes include power, intensity and zoom level. In one embodiment, camera settings (e.g., shutter speed, focus mode, mirror lockup) may also be configured by the user at this step in modeling program 116.

Modeling program 116 receives selected modifiers (step 318). The user selects a scene modifier from the scene modifiers listed in inventory 118. In one embodiment, the user may input selections for scene modifiers into an on-screen menu. Examples of scene modifiers include gels, filters, reflectors, props, etc.

Modeling program 116 determines whether to add additional devices (decision block 320). If the user prefers to add additional devices to the configuration (yes branch, decision block 320), modeling program 116 returns to step 312 and receives a selected device, as described above.

If all devices and modifiers have been selected, placed and oriented (no branch, decision block 320), thus completing the image configuration, or if a pre-set configuration has been received (step 322), modeling program 116 creates a simulation of the photographic setup (step 324). The simulated photographic setup, which includes the effect of the illumination devices and scene modifiers on the subject(s), is displayed.

Subsequent to creating the photographic setup simulation, modeling program 116 determines whether the simulation meets the user's requirements (decision block 326). In one embodiment, modeling program 116 sends a query to the user, asking if requirements have been met. If the simulation does not meet the user's requirements (no branch, decision block 326), modeling program 116 receives a reconfiguration of the subject and/or the devices (step 328). The user alters the configuration as it is displayed. The subject may be changed or placed in a different position in the environment configuration. Devices may be added or subtracted from the setup, and/or positions and/or orientations changed. In addition, scene modifiers may be added or subtracted from the setup, and/or positions and/or orientations changed.

As changes are made, modeling program 116 determines whether the updated simulation meets the requirements. In one embodiment, modeling program 116 sends a query to the user, asking if requirements have been met. Once the simulation meets the user's requirements (yes branch, step 326), modeling program 116 determines whether a pack list is required (decision block 330). A pack list is a list of the equipment, including illumination devices and scene modifiers, which are used in the simulation. The pack list serves as a checklist for the user to pack for the real-world photographic shoot that modeling program 116 simulates. If a pack list is required (yes branch, decision block 330), modeling program 116 creates the list (step 332). In one embodiment, the pack list may be printed on paper for the user to utilize. In another embodiment, modeling program 116 may send the list to a computing device, such as a smartphone or tablet, which the user may bring to the photographic shoot. If a pack list is not required (no branch, decision block 330), the simulation is complete and modeling program 116 ends.

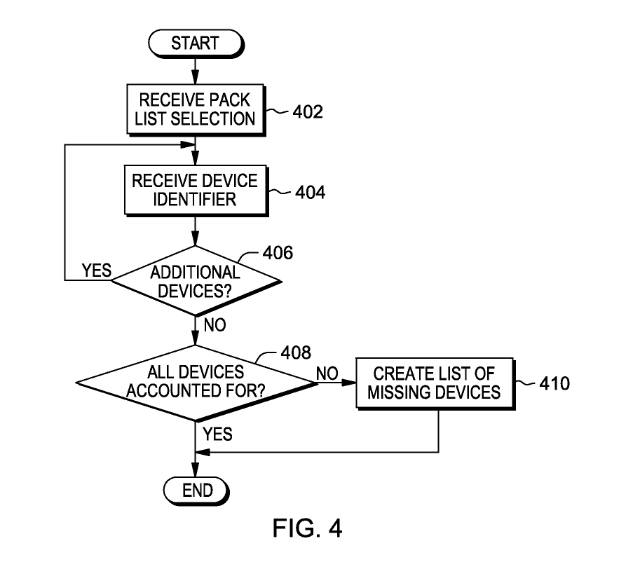

FIG. 4 is a flowchart depicting operational steps of a modeling program, on a computing device within the photographic setup environment of FIG. 1, for checking in equipment after a photographic shoot, in accordance with an embodiment of the present invention. Checking in the equipment following a photographic shoot allows the user to confirm that all equipment taken to the photographic shoot has been returned. Modeling program 116 receives a selection of a pack list that was created, as described in FIG. 3, for a particular photographic shoot (step 402). For example, the user instructs modeling program 116 to open a file for the simulation of a photographic shoot in database 120, and the user chooses the pack list from a list of options.

Modeling program 116 receives the unique identifier associated with a device (step 404). As described in FIG. 2, each piece of the user's equipment has an associated unique identifier. The user selects the identifier associated with the device the user is checking in. In one embodiment, the received pack list is displayed, and the user selects the particular device identifier from the pack list by clicking on it.

Subsequent to receiving the device identifier, modeling program 116 determines if additional devices are required to be checked in (decision block 406). In one embodiment, modeling program 116 queries the user as to whether the user has additional devices to check in. If the user has additional devices to check in (yes branch, decision block 406), modeling program 116 returns to step 404. Once the user has checked in all devices (no branch, decision block 406), modeling program 116 determines whether all devices from the pack list are accounted for (decision block 408). Modeling program 116 compares the pack list from database 120 to the devices that are checked in, and determines whether any devices on the pack list have not been checked in. If any of the devices on the pack list have not been checked in (no branch, decision block 408), modeling program 116 creates a list of the missing devices (step 410). In one embodiment, the list of missing devices may be printed on paper for the user to utilize. In another embodiment, modeling program 116 may send the list to a computing device, such as a smartphone or tablet, which the user may bring to the photographic shoot, or elsewhere, to assist in finding the missing devices.

If all of the devices on the pack list have been accounted for (yes branch, decision block 408), or subsequent to the list of missing devices being created, modeling program 116 ends.

FIG. 5 depicts a block diagram of components of computing device 104 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 104 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Modeling program 116 and database 120 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of computing device 104, camera 106, lighting controller 108, and smart illumination device 110. In these examples, communications unit 510 includes one or more network interface cards. Communications unit 510 may provide communications through the use of either or both physical and wireless communications links. Modeling program 116 and database 120 may be downloaded to persistent storage 508 through communications unit 510.

I/O interface(s) 512 allows for input and output of data with other devices that may be connected to computing device 104. For example, I/O interface(s) 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., modeling program 116 and database 120, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for simulating a photographic setup, the method comprising:
a computer receiving information detailing a first type of device;
the computer determining the received first type of device is not included in a device database;
the computer inserting the first type of device into the device database;
the computer receiving a selection of one or more types of devices wherein the one or more selected types of devices are included in the device database, and wherein the one or more selected types of devices includes the first type of device;
the computer receiving a configuration for each of the one or more selected types of devices; and
the computer creating a simulation of a photographic setup wherein the simulation is based on the one or more selected types of devices and the received configurations.

2. The method of claim 1, wherein a type of device describes an illumination device or a scene modifier.

3. The method of claim 1, wherein receiving information detailing a first type of device further comprises the computer receiving the information from an electronic identification device associated with the one or more selected types of devices.

4. The method of claim 1, wherein the step of inserting the first type of device into the device database further comprises the computer associating a unique identifier with the first type of device.

5. The method of claim 1, wherein the received configuration for each of the one or more selected types of devices includes one or more of placement position, direction, orientation, angle, manufacturer, model, zoom level, intensity, power, modifier manufacturer, modifier model, modifier type, gel color code, and gel transmissive index.

6. The method of claim 1, wherein receiving a configuration for each of the one or more selected types of devices further comprises the computer identifying configuration information for the one or more selected types of devices in one or more of an image file and data describing a previous simulation.

7. A computer program product for simulating a photographic setup, the computer program product comprising:
one or more computer-readable storage media and program instructions stored on the one or more computer-readable storage media, the program instructions comprising:
program instructions to receive information detailing a first type of device;
program instructions to determine the received first type of device is not included in a device database;
program instructions to insert the first type of device into the device database;
program instructions to receive a selection of one or more types of devices wherein the one or more selected types of devices are included in the device database, and wherein the one or more selected types of devices includes the first type of device;
program instructions to receive a configuration for each of the one or more selected types of devices; and
program instructions to create a simulation of a photographic setup wherein the simulation is based on the one or more selected types of devices and the received configurations.

8. The computer program product of claim 7, wherein a type of device describes an illumination device or a scene modifier.

9. The computer program product of claim 7, wherein program instructions to receive information detailing a first type of device further comprises program instructions to receive the information from an electronic identification device associated with the one or more selected types of devices.

10. The computer program product of claim 7, wherein the program instructions to insert the first type of device into the device database further comprises program instructions to associate a unique identifier with the first type of device.

11. The computer program product of claim 7, wherein the received configuration for each of the one or more selected types of devices includes one or more of placement position, direction, orientation, angle, manufacturer, model, zoom level, intensity, power, modifier manufacturer, modifier model, modifier type, gel color code, and gel transmissive index.

12. The computer program product of claim 7, wherein program instructions to receive a configuration for each of the one or more selected types of devices further comprises program instructions to identify configuration information for the one or more selected types of devices in one or more of an image file and data describing a previous simulation.

13. A computer system for simulating a photographic setup, the computer system comprising:
one or more computer processors;
one or more computer-readable storage media;
program instructions stored on the computer-readable storage media for execution by at least one of the one or more processors, the program instructions comprising:
program instructions to receive information detailing a first type of device;
program instructions to determine the received first type of device is not included in a device database;
program instructions to insert the first type of device into the device database;
program instructions to receive a selection of one or more types of devices wherein the one or more selected types of devices are included in the device database, and wherein the one or more selected types of devices includes the first type of device;
program instructions to receive a configuration for each of the one or more selected types of devices; and
program instructions to create a simulation of a photographic setup wherein the simulation is based on the one or more selected types of devices and the received configurations.

14. The computer system of claim 13, wherein a type of device describes an illumination device or a scene modifier.

15. The computer system of claim 13, wherein program instructions to receive information detailing a first type of device further comprises program instructions to receive the information from an electronic identification device associated with the one or more selected types of devices.

16. The computer system of claim 13, wherein the program instructions to insert the first type of device into the device database further comprises program instructions to associate a unique identifier with the first type of device.

17. The computer system of claim 13, wherein the received configuration for each of the one or more selected types of devices includes one or more of placement position, direction, orientation, angle, manufacturer, model, zoom level, intensity, power, modifier manufacturer, modifier model, modifier type, gel color code, and gel transmissive index.

18. The computer system of claim 13, wherein program instructions to receive a configuration for each of the one or more selected types of devices further comprises program instructions to identify configuration information for the one or more selected types of devices in one or more of an image file and data describing a previous simulation.
